(19) United States
(12) Patent Application Publication
(10) Pub. No.: US 2018/0352478 A1
(43) Pub. Date: Dec. 6, 2018

(54) WIRELESS COMMUNICATION SYSTEM AND WIRELESS COMMUNICATION METHOD OF PUSH-TO-TALK

(71) Applicant: INSTITUTE FOR INFORMATION INDUSTRY, Taipei (TW)

(72) Inventor: Wen-Kang JIA, New Taipei City (TW)

(21) Appl. No.: 15/609,033

(22) Filed: May 31, 2017

(51) Int. Cl. H04W 28/14; H04W 4/10; H04W 76/00

(52) U.S. Cl. CPC H04W 28/14; H04W 84/18; H04W 76/005; H04W 4/10

(57) ABSTRACT

The present disclosure provides a wireless communication method and a wireless communication system of push-to-talk. The wireless communication system includes a plurality of wireless communication devices to form a mobile ad hoc network. When one wireless communication device operates in an idle state to receive a call invitation via the mobile ad hoc network, it operates into a play state to play audio content of the call invitation. When this wireless communication device operates in the play or talk state to receive another one or more call invitations, it operates into a play and queue state or a talk and queue state to continue an original playing or talking act and to store audio content of said another one or more call invitations later.

### BACKGROUND

### Field of Invention

The present invention relates to wireless communication. More particularly, the present invention relates to wireless communication method sand wireless communication systems of push-to-talk.

### Description of Related Art

A driver Push-to-talk (PTT) provides one-to-one, one-to-many communication services. PTT similar to traditional radio walkie-talkie and the use of half-duplex mode of service. The most important feature is that the communication between users by pressing the call button, the user can use this service, without other complicated dial-up procedures. In the PTT service, call control is the most important issue. When many people want to speak, press the button to compete for the right to speak. The call control determines only one user with the right to speak and the others are in the listening state.

However, if a unique priority of the global nodes is obtained firstly, it is necessary to control the signaling round-trip acknowledgment resulting in poor efficiency (the delay to the actual talk able may exceed 1 second). If there is no firstly obtained unique priority of the global nodes, it may cause the system to have multiple simultaneous key presses (because the signal of the key-press has not been informed to all nodes).

Traditional approaches tend to avoid, restrict, and prohibit multiple simultaneous push-to-talks. However, these methods obtain the unique priority of the global nodes in advance, and may seriously affect the smooth voice communication processes from pressing the call button to the real speech.

### SUMMARY

The following presents a simplified summary of the disclosure in order to provide a basic understanding to the reader. This summary is not an extensive overview of the disclosure and it does not identify key/critical components of the present invention or delineate the scope of the present invention. Its sole purpose is to present some concepts disclosed herein in a simplified form as a prelude to the more detailed description that is presented later.

According to embodiments of the present disclosure, the present disclosure provides wireless communication method sand wireless communication systems of push-to-talk, to solve or circumvent aforesaid problems and disadvantages.

In one embodiment, a wireless communication system of push-to-talk, includes a plurality of wireless communication devices to form a mobile ad hoc network, and each wireless communication device comprising a temporary storage device, wherein when one wireless communication device of the wireless communication devices operates in an idle state and then receives a call invitation via the mobile ad hoc network, said one wireless communication device operates in a play state to play audio content of the call invitation, wherein when said one wireless communication device operates in the play state and then receives another one or more call invitations, said one wireless communication device operates in a play and queue state to continue playing the audio content of the call invitation and to temporarily store one or more audio contents of said another one or more call invitations, wherein when playing the audio content of the call invitation is finished, said one wireless communication device operates in a play queue state to play said one or more audio contents of said another one or more call invitations..

In one embodiment, when said one wireless communication device operates in the play queue state and then has no audio content in the temporary storage device, the wireless communication device operates in the idle state.

In one embodiment, one of the wireless communication devices firstly operates in a talk state to send out the call invitation via the mobile ad hoc network, and when one or more of others of the wireless communication devices operates in the idle state but do not receive the call invitation yet, said one or more of others of the wireless communication devices operate into the talk state to send out said another one or more call invitations via the mobile ad hoc network.

In one embodiment, each of the wireless communication devices has a push-to-talk button, and when said one wireless communication device operates in the idle state and then its push-to-talk button is pushed, said one wireless communication device operates in the talk state to send the call invitation to others of the wireless communication devices via the mobile ad hoc network.

In one embodiment, when said one wireless communication device operates in the talk state and then its push-to-talk button is released, said one wireless communication device determines whether said one or more audio contents of said another one or more call invitations have been stored temporarily, and then said one wireless communication device plays said one or more audio contents of said another one or more call invitations when said one or more audio contents of said another one or more call invitations have been stored temporarily.

In one embodiment, when said one wireless communication device operates in the talk state and then receives said another one or more call invitations, said one wireless communication device operates in the talk and queue state to continue talking operation and to temporarily store said one or more audio contents of said another one or more call invitations.

In one embodiment, when said one or more audio contents of said another one or more call invitations are finished during the talking operation, operations of said one wireless communication device is changed from the talk and queue state to the talk state through a check queue state.

In one embodiment, after the talking operation is finished, while said one or more audio contents of said another one or more call invitations are proceeding, operations of said one wireless communication device is changed from the talk and queue state to the play queue state, so that said one wireless communication device plays from a beginning of said one or more audio contents of said another one or more call invitations and continue temporarily storing a remaining portion of said one or more audio contents of said another one or more call invitations.

In one embodiment, a wireless communication method of push-to-talk, for a plurality of wireless communication devices to from a mobile ad hoc network, the wireless communication method includes: when one wireless communication device of the wireless communication devices operates in an idle state and then receives a call invitation via the mobile ad hoc network, said one wireless communication device operates in a play state to play audio content of the call invitation; when said one wireless communication device operates in the play state and then receives another one or more call invitations, said one wireless communication device operates in a play and queue state to continue playing the audio content of the call invitation and to temporarily store one or more audio contents of said another one or more call invitations; when playing the audio content of the call invitation is finished, said one wireless communication device operates in a play queue state to play said one or more audio contents of said another one or more call invitations.

In one embodiment, when said one wireless communication device operates in the play queue state and then has no audio content in the temporary storage device, the wireless communication device operates in the idle state.

In one embodiment, one of the wireless communication devices firstly operates in a talk state to send out the call invitation via the mobile ad hoc network, and when one or more of others of the wireless communication devices operates in the idle state but do not receive the call invitation yet, said one or more of others of the wireless communication devices operate into the talk state to send out said another one or more call invitations via the mobile ad hoc network.

In one embodiment, each of the wireless communication devices has a push-to-talk button, and when said one wireless communication device operates in the idle state and then its push-to-talk button is pushed, said one wireless communication device operates in the talk state to send the call invitation to others of the wireless communication devices via the mobile ad hoc network.

In one embodiment, when said one wireless communication device operates in the talk state and then its push-to-talk button is released, said one wireless communication device determines whether said one or more audio contents of said another one or more call invitations have been stored temporarily, and then said one wireless communication device plays said one or more audio contents of said another one or more call invitations when said one or more audio contents of said another one or more call invitations have been stored temporarily.

In one embodiment, when said one wireless communication device operates in the talk state and then receives said another one or more call invitations, said one wireless communication device operates in the talk and queue state to continue talking operation and to temporarily store said one or more audio contents of said another one or more call invitations.

In one embodiment, when said one or more audio contents of said another one or more call invitations are finished during the talking operation, operations of said one wireless communication device is changed from the talk and queue state to the talk state through a check queue state.

In one embodiment, after the talking operation is finished, while said one or more audio contents of said another one or more call invitations are proceeding, operations of said one wireless communication device is changed from the talk and queue state to the play queue state, so that said one wireless communication device plays from a beginning of said one or more audio contents of said another one or more call invitations and continue temporarily storing a remaining portion of said one or more audio contents of said another one or more call invitations.

In view of the foregoing, the wireless communication method sand wireless communication systems of the present disclosure to improve the current push-to-talk (PTT) mechanism, so that they can operate in the mobile ad hoc network (MANET) environment, without the need for complex voice priority arbitration mechanism, and can support multiple simultaneous operation mode. But, it should be noted that there is a time difference between the multiple calls in the system is still prohibited. In other words, each of the wireless communication device once the first access to the reception or talk state and then receive the remaining one or more invitations, in which the invitations are still accepted. The user does not need to change the actual operation method and the process. Compared with the traditional PTT method, the user can make the talk after pressing the call button without wait time, and the performance of the present disclosure is better than the current method.

Many of the attendant features will be more readily appreciated, as the same becomes better understood by reference to the following detailed description considered in connection with the accompanying drawings.

### BRIEF DESCRIPTION OF THE DRAWINGS

The present description will be better understood from the following detailed description read in light of the accompanying drawing, wherein:

FIG. 1 is a block diagram of the wireless communication device according to an embodiment of the present invention;

FIG. 2 is a schematic diagram of the wireless communication device in various states according to an embodiment of the present invention;

FIG. 3 is a schematic diagram of the wireless communication system of a push-to-talk according to an embodiment of the present invention; and

FIG. 4 is a flow chart of the wireless communication method of a push-to-talk according to an embodiment of the present invention.

### DETAILED DESCRIPTION

In the following detailed description, for purposes of explanation, numerous specific details are set forth in order to attain a thorough understanding of the disclosed embodiments. In accordance with common practice, like reference numerals and designations in the various drawings are used to indicate like elements/parts. Moreover, well-known elements or method steps are schematically shown or omitted in order to simplify the drawing and to avoid unnecessary limitation to the claimed invention.

In the detailed embodiment and the claims, unless otherwise indicated, the article “a” or “the” refers to one or more than one of the word modified by the article “a” or “the.”

Through the present specification and the annexed claims, the description involving the “electrical connection” refers to the cases where one component is electrically connected to another component indirectly via other component(s), or one component is electrically connected to another component directly without any other component.

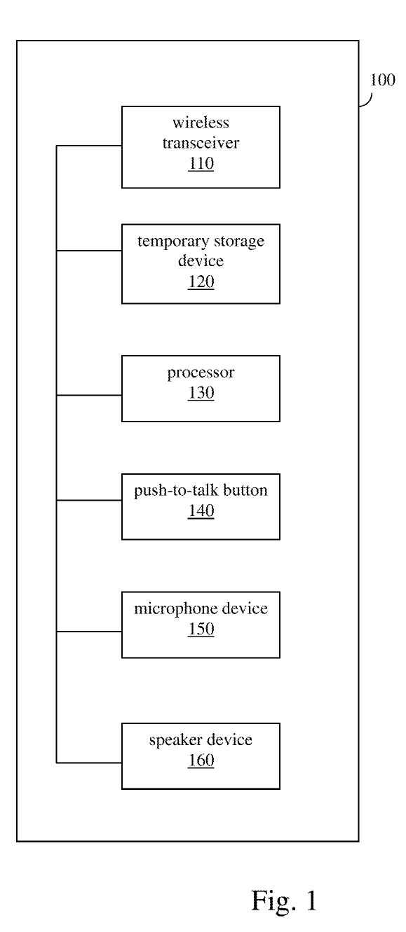

FIG. 1 is a block diagram of the wireless communication device according to an embodiment of the present invention. As shown in FIG. 1, the wireless communication device 100 includes a wireless transceiver 110, a temporary storage device 120, a processor 130, a push-to-talk button 140, a microphone device 150 and a speaker device 160. In structure, the processor 130 is electrically connected to the wireless transceiver 110, the temporary storage device 120, the push-to-talk button 140, the microphone device 150 and the speaker device 160.

For example, the wireless communication device 100 may be a Portable call device, wherein the wireless transceiver 110 may include an antenna and wireless communication device, the temporary storage device 120 may be a volatile memory or nonvolatile memory, the processor 130 may be a CPU or a MCU, the push-to-talk button 140may be a Physical button, a touch button or an induction key, the microphone device 150 may be a microphone, and the speaker device 160 may be a speaker,.

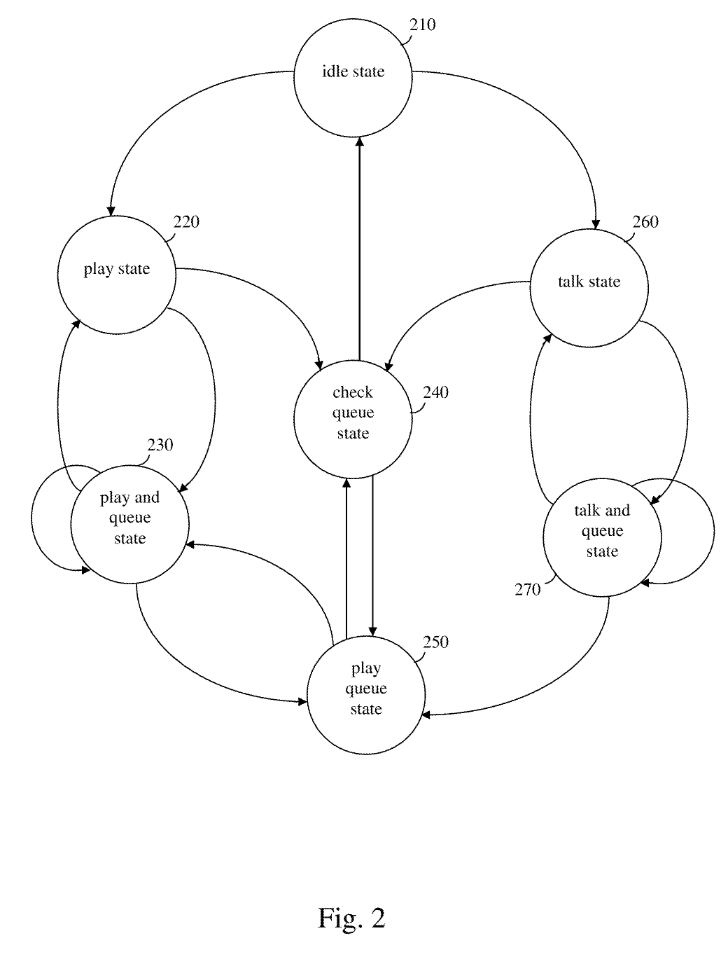

In practice, a plurality of wireless communication devices 100 can form the mobile ad hoc network, so as to constitute the wireless communication system of push-to-talk. For a more complete understanding of the wireless communication device 100 in the push-to-talk communication, referring FIGS. 1 and 2, FIG. 2 is a schematic diagram of the wireless communication device 100 in various states according to an embodiment of the present invention.

The user can use the wireless communication device 100 receives the audio content transmitted from another wireless communication devices in the mobile ad hoc network. In one embodiment, in the idle state 210 the wireless communication device 100 receives a call invitation through the mobile ad hoc network, the wireless communication device 100 operates in the play state 220 to play audio content of the call invitation.

In one embodiment, when the wireless communication device 100 operates in the play state 220 and then receives another one or more call invitations, the wireless communication device 100 operates in a play and queue state 230 to continue playing the audio content of the call invitation and to temporarily store one or more audio contents of said another one or more call invitations in the temporary storage device 120. Specifically, the wireless communication device 100 operates in the play and queue state 230, the wireless transceiver 110 receives one or more audio contents of said another one or more call invitations in sequence, and the processor 130 stores one or more audio contents of said another one or more call invitations in the temporary storage device 120 in the same sequence.

In one embodiment, when playing the audio content of the call invitation is finished in the play and queue state 230, the wireless communication device 100 operates in the play state 220. Then, when play state 220 is finished, the wireless communication device 100 operates in the check queue state 240 to determine whether the temporary storage device 120 stores follow-up audio content of the call invitation. If so, the wireless communication device 100 operates in a play queue state 250 to play this follow-up audio content of the call invitation. When playing this follow-up audio content of the call invitation is finished, the wireless communication device 100 operates in the check queue state 240. If the processor 130 determines the temporary storage device 120 has no follow-up audio content that is not played, the wireless communication device 100 operates in the idle state 210.

Alternatively, In one embodiment, when playing the audio content of the first call invitation is finished in the play and queue state 230, the wireless communication device 100 operates in the play queue state 250 to play the follow-up audio content of the call invitation. When playing this follow-up audio content of the call invitation is finished, the wireless communication device 100 operates in the check queue state 240. If the processor 130 determines the temporary storage device 120 has no follow-up audio content that is not played, the wireless communication device 100 operates in the idle state 210.

In one embodiment, if the wireless communication device 100 still receives new audio content of a new call invitation in the play queue state 250, the wireless communication device 100 operates in the play and queue state 230 and repeats above operations to play all audio contents. Then, the wireless communication device 100 operates in the idle state 210.

In another aspect, the user can use the wireless communication device 100 to send the audio content to the other wireless communication devices in the mobile ad hoc network. In one embodiment, when the wireless communication device 100 operates in the idle state and then its push-to-talk button 140 is pushed, the wireless communication device 100 operates in the talk state 260 to send the call invitation to other wireless communication devices via the mobile ad hoc network.

In one embodiment, when the wireless communication device 100 operates in the talk state and then its push-to-talk button 140 is released, the wireless communication device 100 operates in the check queue state 240 to determine whether audio content of the call invitation has been stored temporarily. If so, the wireless communication device 100 operates in the play queue state 250 to play the audio content of the call invitation. If playing the audio content of the call invitation is finished, the wireless communication device 100 operates in the check queue state 240. If the processor 130 determines the temporary storage device 120 has no follow-up audio content that is not played, the wireless communication device 100 operates in the idle state 210.

In one embodiment, when the wireless communication device 100 receives another operates in the talk state 260 and then receives another one or more call invitations, the wireless communication device 100 operates in the talk and queue state 270 to continue talking operation and to temporarily store said one or more audio contents of said another one or more call invitations. Specifically, the wireless communication device 100 operates in the play and queue state 270, the wireless transceiver 110 receives one or more audio contents of said another one or more call invitations in sequence, and the processor 130 stores one or more audio contents of said another one or more call invitations in the temporary storage device 120 in the same sequence.

In one embodiment, when said one or more audio contents of said another one or more call invitations are finished during above talking operation, operations of the wireless communication device 100 is changed from the talk and queue state 270 to the talk state 260 through the check queue state 240. Then, when the talk state 260 is over (i.e., the push-to-talk button 140 is released), the wireless communication device 100 operates in the check queue state 240 to determine whether the temporary storage device 120 temporarily store audio content of the follow-up call invitation. If so, the wireless communication device 100 operates in the play queue state 250 to play the audio content of the follow-up call invitation. If playing the audio content of the follow-up call invitation is finished, the wireless communication device 100 operates in the check queue state 240. If the processor 130 determines the temporary storage device 120 has no follow-up audio content that is not played, the wireless communication device 100 operates in the idle state 210.

Alternatively, In one embodiment, after above talking operation is finished in the talk and queue state 270, while said one or more audio contents of said another one or more call invitations are proceeding, the wireless communication device 100 operates in the play queue state 250, so that the wireless communication device 100 plays from a beginning of said one or more audio contents of said another one or more call invitations and continues temporarily storing a remaining portion of said one or more audio contents of said another one or more call invitations. If all remaining portion of said one or more audio contents of said another one or more call invitations are temporarily stored, the wireless communication device 100 operates in the play queue state 250 to play the temporarily stored remaining portion of said one or more audio contents of said another one or more call invitations. After aforesaid playing is finished, the wireless communication device 100 operates in the check queue state 240. If the processor 130 determines the temporary storage device 120 has no follow-up audio content that is not played, the wireless communication device 100 operates in the idle state 210.

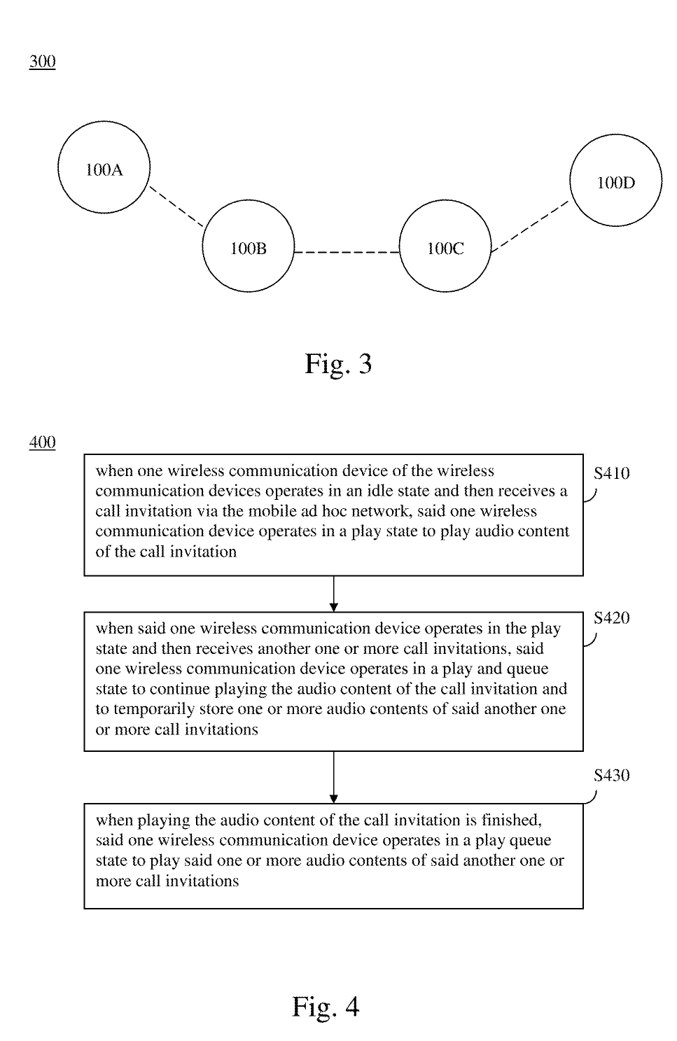

For a more complete understanding of the wireless communication system of the push-to-talk, referring FIGS. 2 and 3, FIG. 3 is a schematic diagram of the wireless communication system 300 of push-to-talk according to an embodiment of the present invention. As shown in FIG. 3, the wireless communication system 300 includes a plurality of wireless communication devices 100A, 1008, 100C and 100D to form the mobile ad hoc network. Any of the wireless communication devices 100A, 1008, 100C and 100D is substantially the same as the wireless communication device 100 and thus is not repeated herein. In practice, the wireless communication system may include more or less than four wireless communication devices shown in FIG. 3.

In one embodiment, if the push-to-talk button of the wireless communication devices 100A and 100D are pressed at the same time or almost simultaneously, the wireless communication devices 100A and 100D operate in the talk state 260. Then, the wireless communication device 100B firstly receives the call invitation from the wireless communication device 100A and operates in the play state 220; similarly, the wireless communication device 100C firstly receives the call invitation from the wireless communication device 100D and operates in the play state 220. Next, the wireless communication device 100B receives the call invitation from the wireless communication device 100D and operates from the play state 220 to the play and queue state 230; similarly, the wireless communication device 100C receives the call invitation from the wireless communication device 100A and operates from the play state 220 to the play and queue state 230. Then, the wireless communication device 100A receives the call invitation from the wireless communication device 100D and operates from the talk state 260 to the talk and queue state 270; similarly, the wireless communication device 100D receives the call invitation from the wireless communication device 100A and operates from the talk state 260 to the talk and queue state 270.

Accordingly, the wireless communication system 300 allows multiple parties to press the push-to-talk button to enter the talk state 260 before receiving the call invitation, without prior coordination, so as to improve system operation efficiency. In addition, it is considered that the number of nodes (such as the wireless communication device 1006, 100C) in the wireless communication system 300 may be affected by the signal delay, and the playback order will be slightly changed, but the multi-party communication process is not affected.

For a more complete understanding of a wireless communication method performed by the wireless communication system, referring FIGS. 2-4, FIG. 4 is a flow chart of the wireless communication method 400 of push-to-talk according to an embodiment of the present invention. As shown in FIG. 4, the wireless communication method 400 includes operations S410, S420 and S430. However, as could be appreciated by persons having ordinary skill in the art, for the steps described in the present embodiment, the sequence in which these steps is performed, unless explicitly stated otherwise, can be altered depending on actual needs; in certain cases, all or some of these steps can be performed concurrently.

In operation S410, when one wireless communication device 1008 of the wireless communication devices 100A, 1008, 100C and 100D operates in the idle state 210 and then receives a call invitation from the wireless communication device 100A via the mobile ad hoc network, the wireless communication device 100B operates in a play state 220 to play audio content of the call invitation;

In operation S420, when the wireless communication device 100B operates in the play state 220 and then receives another one or more call invitations from the wireless communication device 100D, the wireless communication device 100B operates in a play and queue state 230 to continue playing the audio content of the call invitation and to temporarily store one or more audio contents of said another one or more call invitations.

In operation S430, when the wireless communication device 100B finishes playing the audio content of the call invitation from the wireless communication device 100A, the wireless communication device 100B operates in a play queue state 250 to play said one or more audio contents of said another one or more call invitations.

In the wireless communication method 400, when the wireless communication device 100B operates in the play queue state 250 and then has no audio content stored temporarily, the wireless communication device 100B operates in the idle state 210.

In the wireless communication method 400, one (e.g., the wireless communication device 100A) of the wireless communication devices 100A, 1006, 100C and 100D firstly operates in a talk state 260 to send out the call invitation via the mobile ad hoc network, and when one or more (e.g., the wireless communication device 100D) of others of the wireless communication devices 100A, 1006, 100C and 100D operates in the idle state 210 but do not receive the call invitation yet, said one or more of others of the wireless communication devices operate into the talk state 260 to send out said another one or more call invitations via the mobile ad hoc network.

In the wireless communication method 400, when the wireless communication device 100B operates in the idle state 210 and then its push-to-talk button is pushed, the wireless communication device 100A operates in the talk state 260 to send the call invitation to the other wireless communication devices 1006, 100C and 100D via the mobile ad hoc network.

In the wireless communication method 400, when the wireless communication device 100A operates in the talk state 260 and then its push-to-talk button is released, the wireless communication device 100A determines whether said one or more audio contents of said another one or more call invitations have been stored temporarily, and then said one wireless communication device 100A plays said one or more audio contents of said another one or more call invitations when said one or more audio contents of said another one or more call invitations have been stored temporarily.

In the wireless communication method 400, when the wireless communication device 100A operates in the talk state 260 and then receives said another one or more call invitations from the wireless communication device 100D, the wireless communication device 100A operates in the talk and queue state 270 to continue talking operation and to temporarily store said one or more audio contents of said another one or more call invitations.

In the wireless communication method 400, when said one or more audio contents of said another one or more call invitations are finished during the talking operation, operations of said one wireless communication device 100A is changed from the talk and queue state 270 to the talk state 260 through a check queue state 240.

In the wireless communication method 400, after the talking operation is finished, while said one or more audio contents of said another one or more call invitations from the wireless communication device 100D are proceeding, operations of the wireless communication device 100A is changed from the talk and queue state 270 to the play queue state 250, so that the wireless communication device 100A plays from a beginning of said one or more audio contents of said another one or more call invitations from the a wireless communication device 100D and continue temporarily storing a remaining portion of said one or more audio contents of said another one or more call invitations.

In view of the foregoing, the wireless communication method 400 and the wireless communication system 300 of the present disclosure to improve the current push-to-talk (PTT) mechanism, so that they can operate in the mobile ad hoc network (MANET) environment, without the need for complex voice priority arbitration mechanism, and can support multiple simultaneous operation mode. But, it should be noted that there is a time difference between the multiple calls in the system is still prohibited. In other words, each of the wireless communication device once the first access to the reception or talk state and then receive the remaining one or more invitations, in which the invitations are still accepted. The user does not need to change the actual operation method and the process. Compared with the traditional PTT method, the user can make the talk after pressing the call button without wait time, and the performance of the present disclosure is better than the current method.

Although various embodiments of the invention have been described above with a certain degree of particularity, or with reference to one or more individual embodiments, they are not limiting to the scope of the present disclosure. Those with ordinary skill in the art could make numerous alterations to the disclosed embodiments without departing from the spirit or scope of this invention. Accordingly, the protection scope of the present disclosure shall be defined by the accompany claims.

What is claimed is:

1. A wireless communication system of push-to-talk, comprising:
a plurality of wireless communication devices to form a mobile ad hoc network, and each wireless communication device comprising a temporary storage device,
wherein when one wireless communication device of the wireless communication devices operates in an idle state and then receives a call invitation via the mobile ad hoc network, said one wireless communication device operates in a play state to play audio content of the call invitation,
wherein when said one wireless communication device operates in the play state and then receives another one or more call invitations, said one wireless communication device operates in a play and queue state to continue playing the audio content of the call invitation and to temporarily store one or more audio contents of said another one or more call invitations,
wherein when playing the audio content of the call invitation is finished, said one wireless communication device operates in a play queue state to play said one or more audio contents of said another one or more call invitations.

2. The wireless communication system of claim 1, wherein when said one wireless communication device operates in the play queue state and then has no audio content in the temporary storage device, the wireless communication device operates in the idle state.

3. The wireless communication system of claim 1, wherein one of the wireless communication devices firstly operates in a talk state to send out the call invitation via the mobile ad hoc network, and when one or more of others of the wireless communication devices operates in the idle state but do not receive the call invitation yet, said one or more of others of the wireless communication devices operate into the talk state to send out said another one or more call invitations via the mobile ad hoc network.

4. The wireless communication system of claim 1, wherein each of the wireless communication devices has a push-to-talk button, and when said one wireless communication device operates in the idle state and then its push-to-talk button is pushed, said one wireless communication device operates in the talk state to send the call invitation to others of the wireless communication devices via the mobile ad hoc network.

5. The wireless communication system of claim 4, wherein when said one wireless communication device operates in the talk state and then its push-to-talk button is released, said one wireless communication device determines whether said one or more audio contents of said another one or more call invitations have been stored temporarily, and then said one wireless communication device plays said one or more audio contents of said another one or more call invitations when said one or more audio contents of said another one or more call invitations have been stored temporarily.

6. The wireless communication system of claim 5, wherein when said one wireless communication device operates in the talk state and then receives said another one or more call invitations, said one wireless communication device operates in the talk and queue state to continue talking operation and to temporarily store said one or more audio contents of said another one or more call invitations.

7. The wireless communication system of claim 6, wherein when said one or more audio contents of said another one or more call invitations are finished during the talking operation, operations of said one wireless communication device is changed from the talk and queue state to the talk state through a check queue state.

8. The wireless communication system of claim 6, wherein after the talking operation is finished, while said one or more audio contents of said another one or more call invitations are proceeding, operations of said one wireless communication device is changed from the talk and queue state to the play queue state, so that said one wireless communication device plays from a beginning of said one or more audio contents of said another one or more call invitations and continue temporarily storing a remaining portion of said one or more audio contents of said another one or more call invitations.

9. A wireless communication method of push-to-talk, for a plurality of wireless communication devices to from a mobile ad hoc network, the wireless communication method comprising:
when one wireless communication device of the wireless communication devices operates in an idle state and then receives a call invitation via the mobile ad hoc network, said one wireless communication device operates in a play state to play audio content of the call invitation;
when said one wireless communication device operates in the play state and then receives another one or more call invitations, said one wireless communication device operates in a play and queue state to continue playing the audio content of the call invitation and to temporarily store one or more audio contents of said another one or more call invitations; and
when playing the audio content of the call invitation is finished, said one wireless communication device operates in a play queue state to play said one or more audio contents of said another one or more call invitations.

10. The wireless communication method of claim 9, further comprising:
when said one wireless communication device operates in the play queue state and then has no audio content stored temporarily, the wireless communication device operates in the idle state.

11. The wireless communication method of claim 9, wherein one of the wireless communication devices firstly operates in a talk state to send out the call invitation via the mobile ad hoc network, and when one or more of others of the wireless communication devices operates in the idle state but do not receive the call invitation yet, said one or more of others of the wireless communication devices operate into the talk state to send out said another one or more call invitations via the mobile ad hoc network.

12. The wireless communication method of claim 9, wherein each of the wireless communication devices has a push-to-talk button, and the wireless communication method further comprises:
when said one wireless communication device operates in the idle state and then its push-to-talk button is pushed, said one wireless communication device operates in the talk state to send the call invitation to others of the wireless communication devices via the mobile ad hoc network.

13. The wireless communication method of claim 12, further comprising:
when said one wireless communication device operates in the talk state and then its push-to-talk button is released, said one wireless communication device determines whether said one or more audio contents of said another one or more call invitations have been stored temporarily, and then said one wireless communication device plays said one or more audio contents of said another one or more call invitations when said one or more audio contents of said another one or more call invitations have been stored temporarily.

14. The wireless communication method of claim 13, further comprising:
when said one wireless communication device operates in the talk state and then receives said another one or more call invitations, said one wireless communication device operates in the talk and queue state to continue talking operation and to temporarily store said one or more audio contents of said another one or more call invitations.

15. The wireless communication method of claim 14, further comprising:
when said one or more audio contents of said another one or more call invitations are finished during the talking operation, changing operations of said one wireless communication device from the talk and queue state to the talk state through a check queue state.

16. The wireless communication method of claim 14, further comprising:
after the talking operation is finished, while said one or more audio contents of said another one or more call invitations are proceeding, changing operations of said one wireless communication device from the talk and queue state to the play queue state, so that said one wireless communication device plays from a beginning of said one or more audio contents of said another one or more call invitations and continue temporarily storing a remaining portion of said one or more audio contents of said another one or more call invitations.
